(19) United States
(12) Patent Application Publication
(10) Pub. No.: US 2016/0162067 A1
(43) Pub. Date: Jun. 9, 2016

(54) METHOD AND SYSTEM FOR INVOCATION OF MOBILE DEVICE ACOUSTIC INTERFACE

(71) Applicant: Kobo Incorporated, Toronto (CA)

(72) Inventor: James WU, Newmarket (CA)

(73) Assignee: Kobo Incorporated, Toronto, ON (CA)

(21) Appl. No.: 14/560,691

(22) Filed: Dec. 4, 2014

(51) Int. Cl. G06F 3/043; G06F 3/01; G06F 3/0488; G06F 3/041

(52) U.S. Cl. CPC G06F 3/043; G06F 3/0416; G06F 3/016; G06F 3/0488

(57) ABSTRACT

The mobile computing device, or electronic personal display, includes a housing and a touch screen display providing a touch-based gesture interface. The housing includes an acoustic sensor operational to receive acoustic input generated at a tactile interface thereon. The processor is capable of detecting a presence of one or more extraneous objects, such as a water droplet or splash, on the display screen. In response to detecting the presence of the one or more extraneous objects on the display screen, input commands are dissociated from the touch-based gesture interface, and instead, re-associated via re-mapping to a respective acoustic input received at the computing device for performing a given output operation.

### TECHNICAL FIELD

Examples described herein relate to a system and method for transition a mobile computing device to an alternate mode of operation via an acoustic interface.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

As mobile computing devices having functionality for e-reading proliferate, users find it beneficial to be able to operate such devices in many varied surroundings to continue reading their favorite e-book, such as for example, at the beach, at poolside, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device provided with an acoustic interface for transition thereto in an alternate mode of operation, according to an embodiment.

FIG. 2A illustrates an example arrangement of a tactile interface provided upon a side edge of a housing of the mobile computing device for generating an acoustic input in an alternate mode of operation, according to an embodiment.

FIG. 2B illustrates an example arrangement of a tactile interface provided upon a rear surface of a housing of the mobile computing device for generating an acoustic input in an alternate mode of operation, according to an embodiment.

FIG. 3 illustrates a schematic configuration of a computing device for transition to an acoustic interface mode of operation, according to an embodiment.

FIG. 4 illustrates a method of operating a computing device for transition to an acoustic interface alternate mode of operation, according to an embodiment.

### DETAILED DESCRIPTION

Embodiments described herein provide for a computing device that is operable even when water and/or other persistent objects are present on the surface of a display of the computing device. More specifically, the computing device may detect a presence of extraneous objects (e.g., such as water, dirt, or debris) on a surface of the display screen, and perform one or more operations to mitigate or overcome the presence of such extraneous objects in order to maintain a functionality for use as intended, and for viewing of content displayed on the display screen. For example, upon detecting the presence of one or more extraneous objects, such as water droplets, debris or dirt, certain settings or configurations of the computing device may be automatically adjusted, thereby invoking operation via an alternate user interface based on an sensing an acoustic input, whereby gestures from the display touchscreen-based interface mode of operation are nullified or dissociated as valid user input commands to perform a given processor output operation; in lieu thereof, an alternate user interface using acoustic input generated via a tactile action performed on the device becomes associated with, and capable of, effecting the respective output operation.

“E-books” are a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete successive pages.

An “e-reading device”, also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra=mobile computing device, or a wearable computing device with a form factor of a wearable accessory device (e.g., smart watch or bracelet, glass-wear integrated with a computing device, etc.). As another example, an e-reading device can include an e-reading device, such as a purpose-built device that is optimized for an e-reading experience (e.g., with E-ink displays).

### SYSTEM AND HARDWARE DESCRIPTION

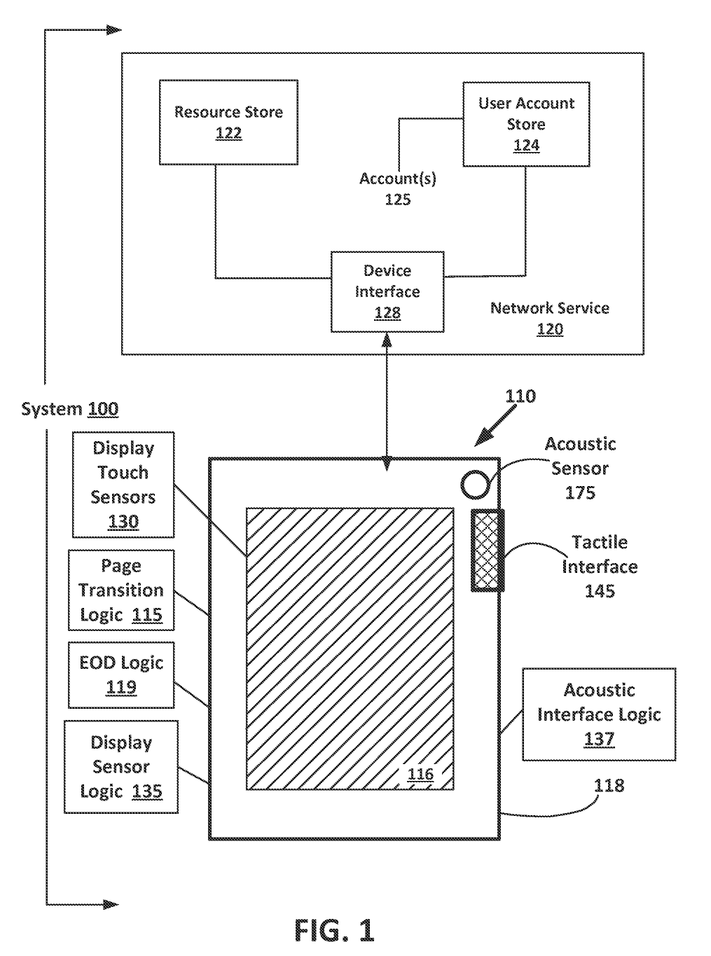

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services in communication with e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with a user account 125. The user account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the resource store 122, which can include, for example, an online store. The device interface 128 can handle input to identify content items (e.g., e-books), and further to link content items to the user account 125.

Yet further, the user account store 124 can retain metadata for individual user account 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display 116 and a housing 118. In an embodiment, the display 116 is touch-sensitive, to process touch inputs including gestures (e.g., swipes). For example, the display 116 may be integrated with one or more touch sensors 130 to provide a touch-sensing region on a surface of the display 116. For some embodiments, the one or more touch sensors 130 may include capacitive sensors that can sense or detect a human body's capacitance as input. In the example of FIG. 1, the touch-sensing region coincides with a substantial surface area, if not all, of the display 116.

In addition to touch-sensitive display 116, housing 118 of the electronic personal device, tablet or e-reader can also be integrated with three dimensional (3D) motion sensor component(s) for sensing motion of an observer's hand, palm or finger in performance of a gesture action in appropriate airspace region proximate acoustic sensors 175. Acoustic sensor(s) 175 will interchangeably be referred to herein as acoustic sensors 175. Acoustic sensors 175 may be disposed on the bezel, front surface, a lateral surface or edge, and/or a rear surface of housing 118. Acoustic sensor(s) 175, in an embodiment, may be implemented using infrared-based motion sensing that operates to sense an input object breaking one or more infrared beams that are projected over a surface of housing 118.

E-reading device 110 further includes acoustic interface logic 137 to interpret acoustic user input generated at tactile interface 145 as commands based on detection by acoustic sensor(s) 175 within housing 118. Tactile interface 145 is provided on a surface of housing 118 to produce a plurality of acoustic signals based on user interactions therewith. Acoustic sensor 175, such as a microphone in one embodiment, is provided with a portion of housing 118 to detect the acoustic signals produced by tactile interface 145.

Acoustic interface logic 137 identifies a signature of the acoustic input as a particular acoustic input within a number of predefined input commands receivable at e-reading device 110. For instance, when an acoustic input as monitored by acoustic sensors 175 correlates with a pre-defined acoustic signature, acoustic interface logic 137 instructs a processor of the e-reader that the associated operation should be performed. For example, input gestures performed at tactile interface 145 of housing 118 of e-reading device 110 such as a tap or a directional swipe may be detected via acoustic sensors 175 and interpreted as respective input commands by acoustic interface logic 137.

In one implementation, the acoustic interface logic 137 can be integrated with acoustic sensors 175. For example, the acoustic sensors 175 can be provided as a modular component that includes integrated circuits or other hardware logic, and such resources can provide some of the acoustic interface logic 137. For example, integrated circuits of acoustic sensors 175 can monitor for an acoustic input and process that input as being of a particular kind

In some embodiments, the e-reading device 110 includes features for providing functionality related to displaying paginated content. The e-reading device 110 can include page transition logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transition logic 115 can operate to enable the user to transition from a given page state to another page state. In some implementations, the page transition logic 115 enables single page transitions, chapter transitions, or cluster transitions (multiple pages at one time).

The page transition logic 115 can be responsive to various kinds of interfaces and actions in order to enable page transition. In one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transition input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display 116 in order to cause a cluster or chapter page state transition, while a tap in the same region can effect a single page state transition (e.g., from one page to the next in such as in a sequence of pages). In another example, a user can specify page turns of different kinds or magnitudes through single taps, sequenced taps or patterned taps on the touch sensing region of the display 116.

According to some embodiments, the e-reading device 110 includes display sensor logic 135 to detect and interpret user input or user input commands made through interaction with the display screen touch sensors 130. By way of example, the display sensor logic 135 can detect a user making contact with the touch-sensing region of the display 116. More specifically, the display sensor logic 135 can detect taps, an initial tap held in sustained contact or proximity with display 116 (otherwise known as a “long press”), multiple taps, and/or swiping gesture actions made through user interaction with the touch sensing region of the display 116. Furthermore, the display sensor logic 135 can interpret such interactions in a variety of ways. For example, each interaction may be interpreted as a particular type of user input for effecting a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116. In a particular embodiment, the display sensor logic 135 may interpret simultaneous contact with multiple touch sensors 175 as a type of non-user input. For example, the multi-sensor contact may be provided, in part, by water and/or other unwanted or extraneous objects (e.g., dirt, debris, etc.) interacting with the touch sensors 130. Specifically, the e-reading device 110 may then determine, based on the multi-sensor contact, that at least a portion of the multi-sensor contact is attributable to presence of water and/or other extraneous objects on the surface of the display 116.

E-reading device 110 further includes extraneous object detection (EOD) logic 119 to adjust one or more settings of the e-reading device 110 to account for the presence of water and/or other extraneous objects being in contact with the display 116. For example, upon detecting the presence of water and/or other extraneous objects on the surface of the display 116, the EOD logic 119 may power off the e-reading device 110 to prevent malfunctioning and/or damage to the e-reading device 110. EOD logic 119 may then reconfigure the e-reading device 110 by invalidating or dissociating a touch screen gesture from being interpreted as a valid input command, and in lieu thereof, associate an alternative type of user interactions as valid input commands, e.g., motion inputs that are detected via the motion sensor(s) 136 will now be associated with any given input command previously enacted via the touch sensors 130 and display sensor logic 135. This enables a user to continue operating the e-reading device 110 even with the water and/or other extraneous objects present on the surface of the display 116, albeit by using the alternate type of user interaction.

One or more embodiments of logic modules, including acoustic interface logic 137 and EOD logic 119, as described herein may be implemented by e-reading device 110 using programmatic modules or components. A programmatic module or component may include a program, a subroutine, a portion of a program, or a software and a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments of acoustic interface logic 137 and EOD logic 119 as described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, flash or solid state memory such as carried on many cell phones and consumer electronic devices and magnetic memory. Computers, terminals, network enabled devices (e.g., mobile devices such as cell phones) are all examples of machines and devices that utilize processors, memory, and instructions stored on computer-readable mediums.

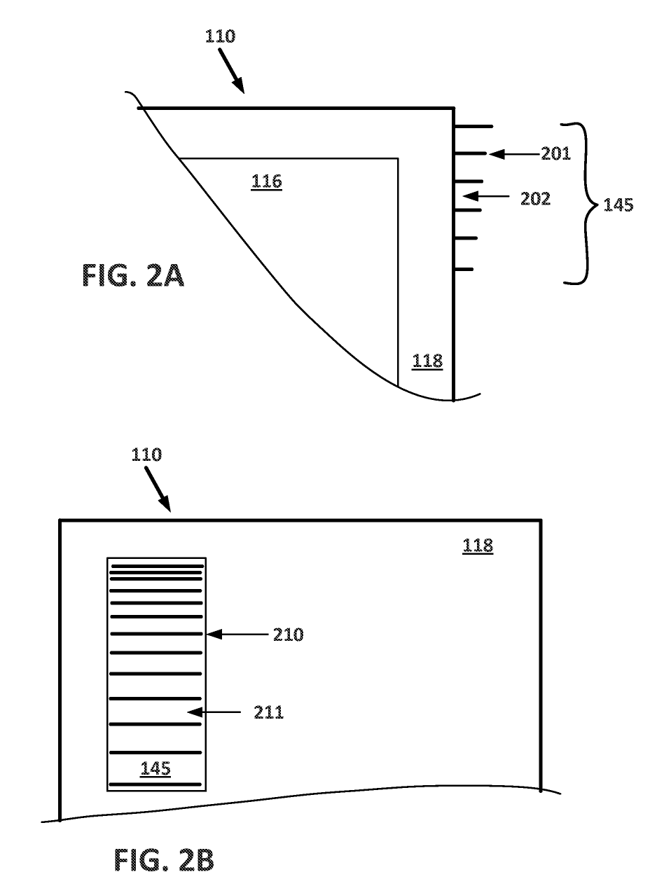

FIG. 2A shows an embodiment of computing device 110 configured with tactile interface 145 upon a side edge of housing 118. For some embodiments, tactile interface 145 is a mechanical structure provided on a surface of the housing of the e-reading device 200. For example, tactile interface 145 may be mechanically coupled to, or superimposed upon a surface of housing 118. Alternatively, tactile interface may be integrally formed as part of the outer surface of housing 118 itself. To enable one-handed operation, tactile interface 145 may be located in an area or region of housing 118 that is readily accessible (e.g., can be swiped) by the user's finger(s) while holding the device with the same hand. For example, tactile interface 145 may be provided on a side and/or back surface of housing 118.

For some embodiments, tactile interface 145 produces the acoustic signals by purely mechanical means (i.e., tactile interface 145 contains no electronic components and/or connections). For example, tactile interface 145 may be formed from a material (such as aluminum or plastic) that resonates and produces a sound/vibration in response to touch or impact. Specifically, tactile interface 145 can comprise a number of peaks and/or valleys that produce a series of tones (which may be collaboratively referred to as a “sound” herein) when swiped (e.g., when touched or contacted in succession). Further, the peaks and valleys may be of varying size, shape, degree, arrangement, and/or pitch (e.g., in a grid pattern) to produce different sounds depending on the direction of swiping. For example, the peaks and valleys may be arranged in decreasing size such that a downward swipe on tactile interface 145 produces a distinctly different sound (e.g., a decrescendo) than an upward swipe on tactile interface 145 (e.g., a crescendo). This enables directionality of the swipe to be recognized from the acoustic signals generated by user action upon tactile interface 145.

Tactile interface 145 can include a number of discrete peaks 201 and valleys 202 that produce a distinct sound (e.g., sequence of tones) when swiped or otherwise touched, in succession, by a user. The peaks 201 and valley 202 may be of varying size, shape, degree, arrangement, and/or pitch, for example, to produce different sounds depending on the direction of swiping.

In an example, the peaks 201 are of varying heights and arranged in order of decreasing magnitude to produce a different sound when the tactile interface 145 is swiped in a downward motion as when the tactile interface 145 is swiped in an upward motion. Specifically, taller peaks 201 (e.g., those towards the top of the tactile interface 145) are likely to resonate louder and/or longer than shorter peaks 201 (e.g., those towards the bottom of the tactile interface 145). As a result, an upward swiping action may be accompanied by a crescendo of sound, whereas a downward swiping action may be followed by a decrescendo of sound. This provides directionality to the sound (i.e., acoustic signals) produced by the tactile interface 145, and may thus enable the e-reading device 110 to distinguish between user inputs corresponding to upward and downward swiping motions. It is contemplated that similar configurations could be deployed to enable directionality in sideways swipe motions as well.

FIG. 2B shows, according to another embodiment, e-reading device 110 configured with tactile interface 145 upon a rear surface of housing 118. Tactile interface 145 includes a number of discrete peaks 210 and valleys 211 that are arranged in a non-periodic configuration, to produce a distinct sound when swiped. Specifically, tactile interface 145 has a finer pitch towards the top than towards the bottom. As a result, swiping tactile interface 145 may produce a chirping sound with varying harmonics, depending on the direction of the swipe (e.g., upward or downward swiping motion). Acoustic interface logic 137 in conjunction with processor 310 of e-reading device 110 may therefore determine the directionality of the acoustic signals produced at tactile interface 145 based on sound harmonics.

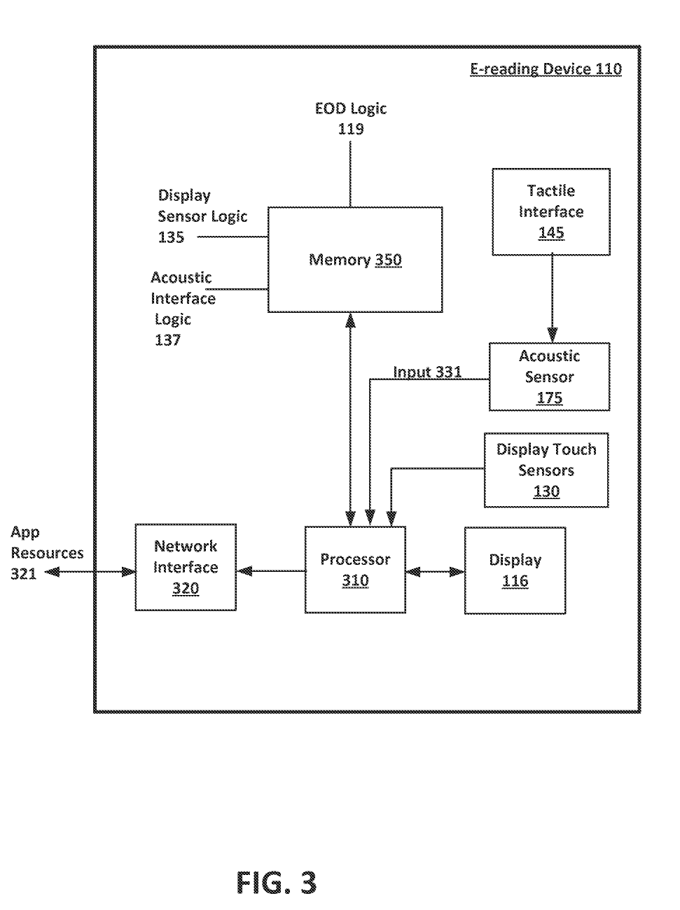

FIG. 3 illustrates a schematic architecture, in one embodiment, of e-reading device 110 as described above with respect to FIGS. 1 and 2. With reference to FIG. 3, e-reading device 110 further includes a processor 310, a memory 350 storing instructions, and logic pertaining at least to display sensor logic 135, extraneous object detection (EOD) logic 119 and acoustic interface logic 137.

The processor 310 can implement functionality using the logic and instructions stored in the memory 350. Additionally, in some implementations, the processor 310 utilizes the network interface 320 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, e-reading device 110 can receive application resources 321, such as e-books or media files, that the user elects to purchase or otherwise download via the network service 120. The application resources 321 that are downloaded onto the e-reading device 110 can be stored in the memory 350.

In some implementations, the display 116 can correspond to, for example, a liquid crystal display (LCD) or light emitting diode (LED) display that illuminates in order to provide content generated from processor 310. In some implementations, the display 116 can be touch-sensitive. For example, in some embodiments, one or more of the touch sensors 130 may be integrated with the display 116. In other embodiments, the touch sensors 130 may be provided (e.g., as a layer) above or below the display 116 such that individual touch sensors 130 tracks different regions of the display 116. Further, in some variations, the display 116 can correspond to an electronic paper type display, which mimics conventional paper in the manner in which content is displayed. Examples of such display technologies include electrophoretic displays, electro-wetting displays, and electro-fluidic displays.

The processor 310 can receive input from various sources, including the touch sensor components 130 of display 116, from acoustic sensors 175 at housing 118 and/or other input mechanisms (e.g., buttons, keyboard, mouse, microphone, etc.). With reference to examples described herein, the processor 310 can respond to input 331 detected at acoustic sensors 175. Processor 310 in conjunction with acoustic interface logic 137 interprets the plurality of acoustic signals produced at tactile interface 175 as respective ones of a plurality of user input commands to perform related activities while reading paginated content comprising an e-book. In some embodiments, the processor 310 responds to inputs 331 from the acoustic sensor 175 in order to facilitate or enhance e-book activities such as generating e-book content on the display 116, performing page transitions of the displayed e-book content, powering on or off e-reading device 110 and/or display 116, activating a screen saver or sleep mode state, launching or closing an application, and/or otherwise altering a state of the display 116.

Still with reference to FIG. 3 and the examples described herein, the processor 310 can respond to input 331 from the acoustic sensors 175. In some embodiments, the e-reading device 110 includes acoustic interface logic 137 that acts in conjunction with processor 310 to respond to to acoustic inputs as monitored via acoustic sensors 175, and further processes the input as a particular input or type of input.

In some embodiments, the memory 350 may store display sensor logic 135 that monitors for user interactions detected through the touch sensor 130 of display 116, and further processes the user interactions as a particular input or type of input.

For some embodiments, the display sensor logic 135 may detect the presence of water and/or other extraneous objects, including debris and dirt, on the surface of the display 116. For example, the display sensor logic 135 may determine that extraneous objects are present on the surface of the display 116 based on a number of touch-based interactions detected via the display touch sensors 130 and/or a contact duration (e.g., a length of time for which contact is maintained with corresponding touch sensors 130) associated with each interaction. More specifically, the display sensor logic 135 may detect the presence of water and/or other extraneous objects if a detected interaction falls outside a set of known gestures (e.g., gestures that are recognized by the e-reading device 110). Such embodiments are discussed in greater detail, for example, in co-pending U.S. patent application Ser. No. 14/498,661, titled “Method and System for Sensing Water, Debris or Other Extraneous Objects on a Display Screen,” filed Sep. 26, 2014, which is hereby incorporated by reference in its entirety.

For some embodiments, the display sensor logic 135 further operates in conjunction with acoustic interface logic 137 for adjusting one or more settings of the e-reading device 110 in response to detecting the presence of water and/or other extraneous objects on the surface of the display 116. For example, the acoustic interface logic 137 may configure the e-reading device 110 to operate in a “splash mode” when water and/or other extraneous objects are present (e.g., “splashed”) on the surface of the display 116. While operating in splash mode, one or more device configurations may be altered or reconfigured to enable the e-reading device 110 to continue operating, but albeit via an acoustic mode while water and/or other extraneous objects are present on the surface of the display 116. More specifically, the acoustic interface logic 137 may perform one or more operations to mitigate or overcome the presence of extraneous objects (e.g., such as water) on the surface of the display 116. Accordingly, the acoustic interface logic 137 may be activated upon detecting the presence of extraneous objects on the surface of the display 116 via EOD logic 119 in conjunction with processor 310.

For some embodiments, the acoustic interface logic 137 may reconfigure one or more actions (e.g., input responses) that are to be performed by the e-reading device 110 in response to user inputs. For example, the acoustic interface logic 137 may disable or dissociate certain actions (e.g., such as performing multi-page and/or chapter transitions) that are triggered by user touchscreen-based interactions (e.g., requiring concurrent contact at multiple distinct locations on the display 116) and/or persistent user interactions (e.g., requiring continuous contact with the touch sensors 130 over a given duration) because such interactions could be misinterpreted by the display sensor logic 135 given the presence of extraneous objects on the surface of the display 116. The disabling or dissociation may be accomplished by terminating electrical power selectively to those components implicated in a portion of circuitry, using interrupt-based logic to selectively disable the components involved, such as touch sensors 130 disposed in association with display 116.

Additionally, and/or alternatively, the acoustic interface logic 137 may enable a new set of acoustic input actions performed at tactile interface 145 to be validated or recognized in performance of input commands to e-reading device 110. For example, the acoustic interface logic 137 may remap, and then re-associate, one or more user input commands to a new set of acoustic input actions as detected by acoustic sensor(s) 175. With acoustic sensors 175 activated for use in conjunction with acoustic interface logic 137, a new set of user actions performed at tactile interface 145 of e-reading device 110 may be validated or recognized, and acted upon, only when water and/or other extraneous objects are present on the surface of the display 116. The acoustic motion may be recognized as having a direction and/ or a swipe speed of motion of the user action thereon, in an embodiment. In this manner, the new set of acoustic actions may enable the e-reading device 110 to operate in an optimized manner while the water and/or other extraneous objects are present.

In other embodiments, input commands generated via tactile interface 145 may be re-associated with output actions of processor 310, such as, but not limited to, opening an e-book, closing an e-book, turning a page, adding a bookmark on a page of text content being displayed, removing the bookmark, opening a menu, initiating a change in screen brightness, initiating a reading mode change, initiation of a sleep mode, and a device power-off command.

### METHODOLOGY

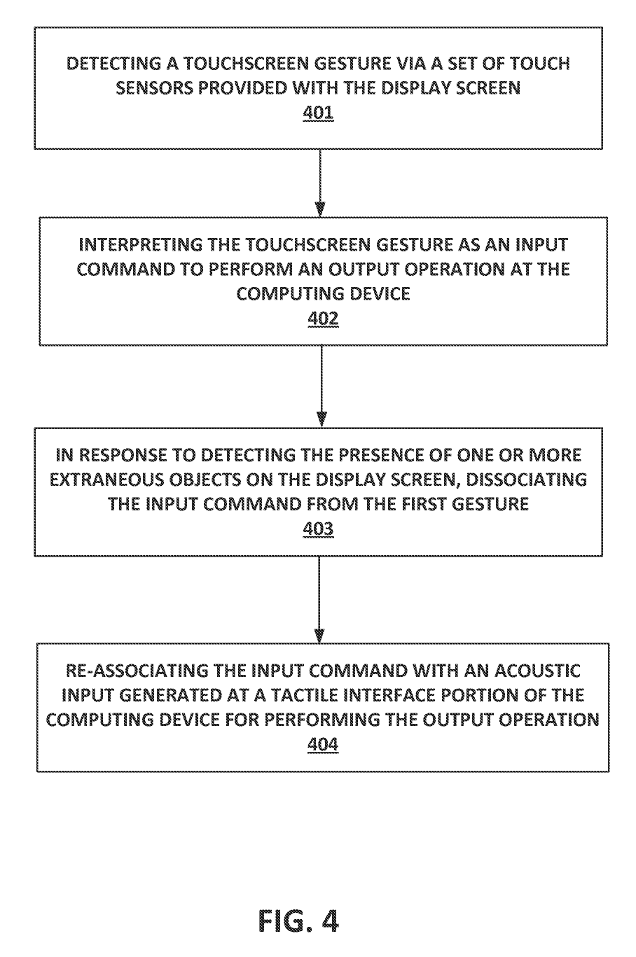

FIG. 4 illustrates a method of operating an e-reading device 110 to an alternate gesture mode when water and/or other extraneous objects are present on the display 116, according to one or more embodiments. In describing the example of FIG. 3, reference may be made to components such as described with FIGS. 1, 2 and 3 for purposes of illustrating suitable components and logic modules for performing a step or sub-step being described.

With reference to the example of FIG. 3, the e-reading device 110, via EOD logic 119, may detect the presence of one or more extraneous objects on a surface of the display 116. For some embodiments, the display sensor logic 135 may detect the presence of extraneous objects on the surface of the display 116 based on a number of touch-based interactions detected via the touch sensors 130 and/or a contact duration associated with each of the interactions. For example, the display sensor logic 135 may determine that extraneous objects are present on the surface of the display 116 if a detected interaction falls outside a set of known gestures.

At step 401, a touchscreen gesture upon display 116 is detected via the set of touch sensors 130 is interpreted as an input command to perform an output operation at e-reading device 110.

At step 402, the gesture enacted at the display screen is interpreted by display sensor logic 135 as an input gesture command to perform an associated output operation, via processor 310, at e-reading device 110.

At step 403, extraneous object detection logic 119 detects the presence of one or more extraneous objects on a surface of the display 116 in response to detecting the presence of the one or more extraneous objects on the display screen, and in response thereto, acoustic interface logic 137 disables or dissociates certain user input commands associated with touch gestures such as a tap, a sustained touch, a swipe or some combination thereof, received at display 116 as detected from display touch sensors 130.

At step 404, processor 310 in conjunction with acoustic interface logic 137 then re-maps and re-associates a set of user input commands by associating ones of the set with respective acoustic input actions as detected via acoustic sensors 175. Example acoustic input actions may include a directional swipe or a tap at tactile interface 145, as detected via acoustic sensors 175 and interpreted by acoustic interface logic 137 to accomplish respective output operations for e-reading actions, such as turning a page (whether advancing or backwards), placing a bookmark on a given page or page portion, placing the e-reading device in a sleep state, a power-on state or a power-off state, and navigating from the e-book being read to access and display an e-library collection of e-books that may be associated with user account store 124.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method executed in a processor of a computing device, the computing device including a memory storing instructions and a display screen having touch functionality, the processor capable of detecting a presence of one or more extraneous objects on the display screen, the method comprising:
detecting a touchscreen gesture enacted upon a set of touch sensors provided with the display screen;
interpreting the touchscreen gesture as an input command to perform an output operation at the computing device;
in response to detecting the presence of the one or more extraneous objects on the display screen, dissociating the input command from the touchscreen gesture; and
re-associating the input command with an acoustic input for performing the output operation, the acoustic input generated at a tactile interface portion of the computing device.

2. The method of claim 1, wherein the touchscreen gesture is interpreted as an input command to enact a page transition operation upon digital content displayable in a sequence of pages upon the display screen.

3. The method of claim 1 wherein the acoustic input generated at tactile interface portion of the computing device is selected from the group consisting of: an upward swipe, a downward swipe, a sideways swipe and a tap performed at tactile interface portion.

4. The method of claim 1 wherein the output operation comprises a bookmark operation associated with a page in a sequence of pages.

5. The method of claim 1 wherein the output operation comprises a return to an e-library collection of e-books.

6. The method of claim 1, wherein the output operation comprises a sleep mode state change of the computing device.

7. The method of claim 1, wherein the output operation comprises a power-off state change of the computing device.

8. The method of claim 1 wherein the processor detects an aspect of the acoustic input generated at tactile interface portion of the computing device as having one of a direction and a swipe speed.

9. The method of claim 1 wherein the tactile interface portion includes a plurality of peaks and valleys to produce a plurality of acoustic signals in response to user interactions thereupon.

10. A computing device comprising:
a display screen including touch functionality;
a housing that at least partially circumvents the display screen, the housing including a tactile interface portion; and
a processor provided within the housing that detects a presence of one or more extraneous objects on the display screen, the processor further operable to:
detect a touchscreen gesture enacted upon a set of touch sensors provided with the display screen;
interpret the touchscreen gesture as an input command to perform an output operation at the computing device;
in response to detecting the presence of the one or more extraneous objects on the display screen, dissociate the input command from the touchscreen gesture; and
re-associate the input command with an acoustic input for performing the output operation, the acoustic input generated at a tactile interface portion provided at the computing device.

11. The computing device of claim 10 wherein the acoustic input generated at tactile interface portion of the computing device is selected from the group consisting of: an upward swipe, a downward swipe, a sideways swipe and a tap performed at tactile interface portion.

12. The computing device of claim 10 wherein the touchscreen gesture is interpreted as an input command to enact a page transition operation upon digital content displayable as a sequence of pages upon the display screen.

13. The computing device of claim 10 wherein the output operation comprises a bookmark operation associated with a page in a sequence of pages.

14. The computing device of claim 10 wherein the output operation comprises a return to an e-library collection of e-books.

15. The computing device of claim 10 wherein the output operation comprises a sleep mode state change of the computing device.

16. The computing device of claim 10 wherein the output operation comprises a power-off state change of the computing device.

17. The computing device of claim 10 wherein the processor detects an aspect of the acoustic input generated at tactile interface portion as having one of a direction and a swipe speed.

18. The computing device of claim 10 wherein the tactile interface portion includes a plurality of peaks and valleys to produce a plurality of acoustic signals in response to user interactions thereupon.

19. A non-transitory computer-readable medium storing instructions that, when executed by a processor of a computing device, cause the processor to perform operations that include:
detecting a touchscreen gesture enacted upon a set of touch sensors provided with a display screen;
interpreting the touchscreen gesture as an input command to perform an output operation at the computing device;
in response to detecting a presence of one or more extraneous objects on the display screen, dissociating the input command from the touchscreen gesture; and
re-associating the input command with an acoustic input for performing the output operation, the acoustic input generated at a tactile interface portion provided at the computing device.
